(19) United States
(12) Patent Application Publication
(10) Pub. No.: US 2006/0120385 A1
(43) Pub. Date: Jun. 8, 2006

(54) Method and system for creating and managing multiple subscribers of a content delivery network

(76) Inventors: Darrell Todd Atchison, Kuttawa, KY (US); Dan Westman, Brentwood, TN (US)

Correspondence Address: REED SMITH LLP, Suite 1400, 3110 Fairview Park Drive, Falls Church, VA, 22042, US

(21) Appl. No.: 11/291,970

(22) Filed: Dec. 2, 2005

Related U.S. Application Data
(60) Provisional application No. 60/632,799, filed on Dec. 2, 2004.

(51) Int. Cl. H04N 7/173; H04L 12/56

(52) U.S. Cl. 370/400; 725/105

(57) ABSTRACT

A system for the real-time transmission, storage, retrieval and credentialing of video (and/or audio) data from a plurality of possible sources (subscribers) is accessible via a network, such as the Internet, to a plurality of authorized viewer clients and the subscriber for the purposes of management, addition or deletion of stored content, changing or creating of the live content location universal resource locator (URL) or the of credentials for viewers.

This application claims priority under 35 USC §120 to Provisional Application Ser. No. 60/632,799, filed Dec. 2, 2004, which is hereby incorporated by reference.

### BACKGROUND OF THE INVENTION

1. Technical Field

The invention relates to the field of audio/video streaming and is an integrated system for managing, archiving, distributing and credentialing subscribers, viewers and content. Specifically, encoder software combined with proprietary server side code, authentication process and graphical user interface are combined to create an “overlay” to simplify a traditionally, complicated, technical process.

2. Summary of the Invention

The invention combines downloadable software, proprietary code, a database, an authentication process and graphical user interface to create a unique, hierarchal management environment for streaming media distribution systems. The system and software suite “overlays” a traditional streaming media distribution system to enable a highly efficient method and system for: (1). The management by a super user of network resources and (2), the ability to create and manage multiple users or subscribers who purchase some portion of network storage and bandwidth on a temporal basis for the purpose of streaming live or on-demand audio/video (a/v) content).

After downloading an a/v encoder/manager software application, subscribers may (a) manage viewers (or audience members who wish to view live or on-demand content transmitted or streamed by the subscriber), (b) manage content archive and distribution (a/v files created and uploaded by subscribers for the purpose information, news, general correspondence or entertainment, may be stored and distributed) (c) manage usage (stop, cap or add more bandwidth as needed for the purpose of enabling more viewer minutes), (d) manage the authentication or security of a/v content (users may add a user name and password requirement to view content).

3. Description of the Prior Art

As would be understood by those in this field of technology, there are multiple methods for distributing digital a/v content over the Internet. At the time of this application's filing, several proprietary MPEG 4 variants for streaming media exist and are widely available for the purposes of distributing streaming media objects over public Internet Protocols (IP). Microsoft Windows Media™ (.asf, .wmv, .wma), QuickTime™ (.mov), Real Media™ (.rm) are currently the leading proprietary MPEG 4 variants and are all, more or less based on the ISO/IEC 14496 standard. These “container” standards where developed as part of the ISO/IEC 14496 “second phase” or ISO/IEC 14496-2 meeting of the on going ISO/IEC MEPG consortium in 1998.

MPEG-4, introduced in late 1998, is the designation for a group of audio and video coding standards and related technology agreed upon by the ISO/IEC Moving Picture Experts Group (MPEG). The primary use of the MPEG-4 standards are streaming media over the world wide web, CD distribution and other bandwidth sensitive distributions like portable devices and certain broadcast television applications.

MPEG-4 absorbs many of the features of MPEG-1 and MPEG-2 and other related standards, adding new features such as extended VRML (Virtual Reality Modeling Language) support for 3D rendering, object-oriented composite files (including audio, video and VRML objects), support for externally-specified Digital Rights Management (DRM) and various types of interactivity.

A more easily understandable explanation of MPEG 4 might be inferred from the “container” reference. If we think of the MPEG 4 (and all of its proprietary variants) as “containers”, then one can visualize a technology that is capable of holding and transporting audio/video information, certain metadata, asynchronous communication channels and other information in low bandwidth environments. This container methodology lends itself well to low bandwidth environments by employing varying methods of advanced error correction, block cipher methodologies or, more generally, algorithms that employ motion compensated inter-frame prediction, the general foundational bases for most modern compression since MPEG 1 was introduced in 1988.

As mentioned previously, certain proprietary variants of MPEG 4 have become well established as industry standards for web transport of a/v content. Although QuickTime, Widows Media, and Real Networks have all positioned themselves as “standards” for streaming media, they are continually under pressure from innovative “open source” MPEG-4 codec projects like OpenDivX and XviD, as the market and emergent standards are still unknown.

Current systems for media management and distribution over electronic networks or the web require the assembly of network resources and hardware, must be administered by a technical individual and require a significant investment. For this reason, most “average users” rarely, if ever, utilize the live or prerecorded media capabilities of an electronic, interconnected world.

A typical best practices scenario for distributing and managing digital or streaming content over the web will require (1) the purchase of at least one server and server operating system, (2) the licensing of a particular codec by arranging to purchase encoding software (Windows, Real, QuickTime or other MPEG-4 variant), (3) the procurement of a co-location facility to place the server, and (4) acquiring a service level agreement for the purchase of bandwidth, maintenance and security on the server (if not staffed internally). This scenario may be relatively easy for those in the technology elite, but hardly a desirable undertaking for the “ordinary user”.

FIGS. 1 and 2 collectively illustrate the following: (A) domination of electronic media and communications industries by large institutions and corporations; (B) the emergence of accepted “patterns” or “methods” for electronic story telling or reporting such as the documentary, the news reel, the motion picture, the live remote, the situation comedy, the interview and talk radio, to name a few; (C) a convergence of the tools and technologies used to create and distribute all forms of these media types into an era of “reasonably availability” (That is to say, the illustrations collectively show a progression or evolution to a point where tools and technologies used to create and distribute media of the highest quality, are available to anyone with reasonable means, intellect and desire); and (D) a correlation between computational power and reasonable availability of higher quality media tools such as cameras, PC's and a ubiquitous connectivity network easily reachable by the general public.

FIGS. 1 and 2 broadly illustrate a very complex, multi-layered paradigm shift still in progress. Therefore, the inferences are not meant to be ones of exact dates or points of departure. The illustrations are merely an attempt to demonstrate generally, where a point of “access for all” began, the historic and technological processes at work, and to make certain assumptions about the present and future as they relate to the invention.

As the convergence of technologies combines with the development and “build out” of a ubiquitous wireless network with increasingly large bandwidth capabilities, the stage is set to deliver a variety of powerful media forms across the global network.

Indeed, the technology claims made possible herein are precisely the result of our moving along the technology lines of creativity that have opened up channels of intellectual development in the areas of widely disseminated, wireless networks combined with ever increasing broadband connectivity.

It is the very existence of these environments that enable the creative development of advanced audio and video network transmission systems that both enable and enhance the experience of both distributing and receiving the disparate sights and sounds of the planet.

### BRIEF DESCRIPTION OF THE DRAWINGS

The present invention will be described herein below in conjunction with the accompanying drawings illustrating the invention, wherein:

FIG. 1 shows a graphical illustration of electronic media computational power versus availability during the 1900-1959 time frame;

FIG. 2 shows a graphical illustration of electronic media computational power versus availability during the 1960-present time frame;

FIG. 3 illustrates one preferred embodiment of the structure and operation of the present invention;

FIG. 4 illustrates a block diagram that represents the typical apparatus that would be used by a subscriber;

FIG. 5 shows a block diagram representing a gatekeeper server according to FIG. 3 and its relationship to a subscriber and a viewer; and FIG. 6 shows block diagram representation of a typical media server configuration.

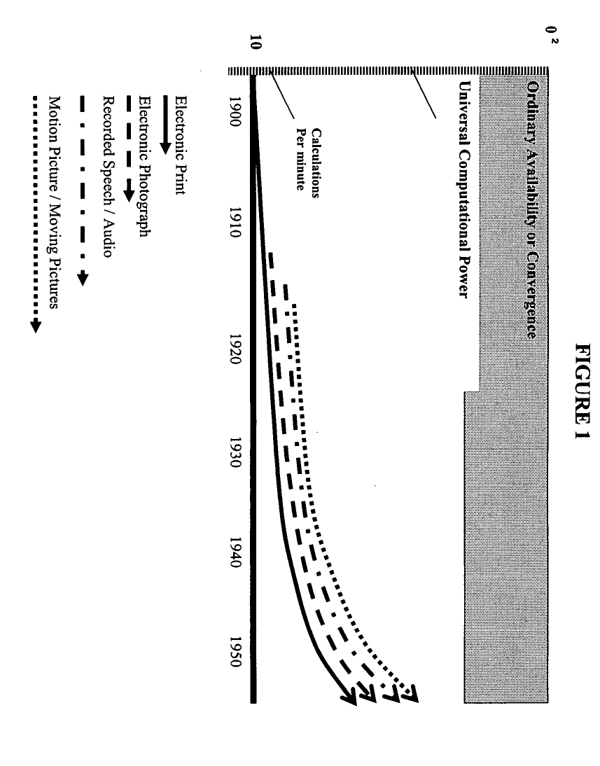

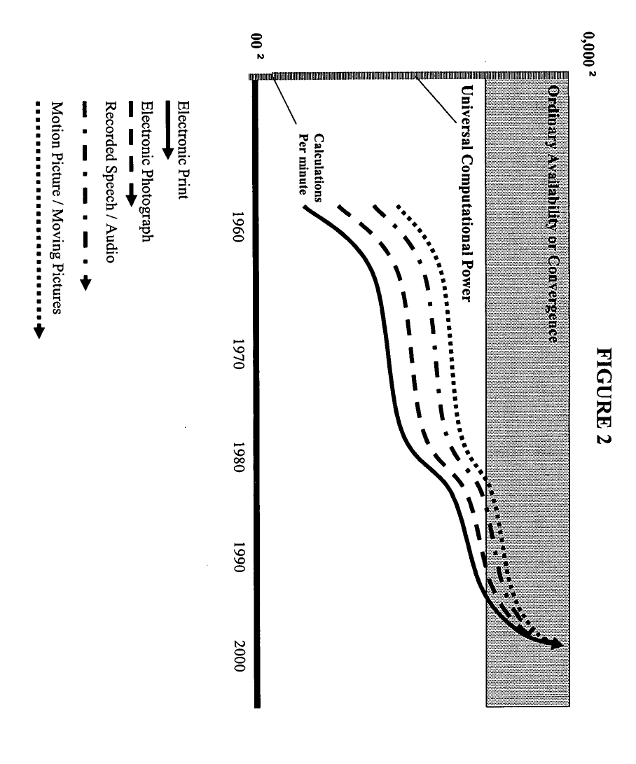

### DETAILED DESCRIPTION OF THE PREFERRED EMBODIMENTS

In its current embodiment, the system, comprised of an a/v encoder/manager engine, proprietary dynamic link libraries, and a database engine, is combined via an object oriented programming language and accessible to both administrator (super user) and subscriber via the World Wide Web; and enhances the capabilities of a traditional streaming media distribution system, by allowing super users to: 1. create and manage subscriber accounts, 2. assign rights or parameters to the subscriber account e.g. bandwidth limits, active/inactive, suspend, billing rates or increments etc. 3. manage network resources e.g. server load, stream paths (dynamic routing of stream paths or url, monitor network traffic etc., and 4. parse information regarding subscriber usage for efficient automated billing transactions.

Super users create subscriber accounts who download an a/v encoder/manager engine that when installed by a subscriber provides: a. an authentication and log in procedure, b. a user interface for the creation and management of live streaming content (one to many or peer-to-peer), b. an archival and distribution system for on-demand content, c. credentialing of live and on-demand content e. an automated notification process to viewers, and f. the manipulation of other webcasting criteria e.g. changing of ports etc. Once installed, and a subscriber has logged on and is authenticated, he or she is displayed various information about their subscriber account in the a/v encoder/manager engine, including but not limited to: a. bandwidth utilization, e.g. amount of bandwidth being utilized by a broadcast in progress, b. broadcast length, c. current bit rate, e. dropped frames, f. number of current viewers g. viewer minutes remaining (the amount of viewer minutes that remain based on views at 128 kbps), h. a number of bit rates available for the transmission of audio, video or both, i. a source selection, (subscriber may use an attached USB, DV, or composite a/v device, available device drivers appear in a source selection window for audio and video) or may choose to broadcast SMPTE Color Bars and Tone, j. set archive location and change archive file name (the ability to move and manipulate archives of live broadcasts), k. a series of controls for broadcasting local stored archival content, and l. a set of controls for uploading, archiving and distributing on-demand content.

The invention greatly enhances current streaming media distribution methodologies and provides a level of granularity previously unavailable to the casual user as well as enables the creation and efficient administration of a content delivery network (CDN) by the super user.

In its current embodiment, subscriber may originate streaming audio and/or video from a mobile environment and remain remotely detached from a cabled or otherwise hard-wired connection located within a building structure, for example. Each mobile source includes a source of audio and/or video data, such as a recorded video file or a video camera operating in real time and an Internet connection device for communicating with and connecting the subscriber client to a remote server(s) via the Internet. Once the subscriber has been authenticated, a signal is transmitted to the subscriber to enable the subscriber to begin transmitting (i.e. streaming) the audio and/or video data.

The subscriber first transmits information identifying the encoder/decoder, referred to herein as a codec which will be used for the video data transmission, together with information identifying a publishing point for the video data which will be sent. The server, upon receiving the information, employs the proper codec and identifies the subscriber and authenticates the identification. The server stores the identifying data and allocates data storage for the video file about to be received. That is, the server provides archival storage, under software control, for the particular video file about to be received together with an identification of the subject matter of the file or other appropriate file identification, an identification of the providing subscriber (collectively referred to as the “publishing point”). The server also provides for each archived file, an identification of the viewer clients to which access will be permitted (referred to as a “permission”).

In short, then, when a subscriber desires to include a stored video file or real time digitized data stream into a library of files accessible to the viewer client, the subscriber simply initiates a communication link, preferably via a wireless cell card, through the Internet network to a centralized, remote master server.

Subscribers are authenticated via a central authentication server that is logically and physically distinct from the media servers. Once authenticated, subscribers may begin streaming. Upon initiation of streaming by subscribers, the media server to which the subscriber is currently streaming will contact the authentication server to ensure proper limits are within prescribed boundaries for this subscriber, among other details to allow or disallow viewers to access the subscriber's stream.

It will thus be appreciated that the same server may serve a number of independent subscribers, each having its own, or overlapping groups of customers or viewer clients which are authorized to access the data, as long as the user clients have secured authorization, for example, by paying subscriber fees or being employees or students with proper identification indicia.

A number of advantages occur as a result of the present invention. First, the source may be mobile. That is, it need not be located in the same location for successive uses. Incident to this advantage, there is no need to have a server at the source. Rather, a centrally located server communicating with the source via the Internet (preferably, wireless) is preferred. The mobile embodiment contemplates commercially available high speed wireless Internet connections such as CDMA, GSM, EVDO and the like. Moreover, literally, the source may be in motion while generating the streaming video, as in a news-gathering van.

Moreover, the system of the present invention serves both subscribers and viewer clients in the same system. Multiple subscribers, independent of one another, may be accommodated by the same server; and there is no limit to the number and composition of viewer clients that may have access to specific files and streams, provided they are authorized.

Further, the implementation of a publishing point is accomplished in real time without human intervention. The files associated with a particular publishing point may be accessed in real time by a viewer client, or viewed as an archived file without a systems administrator and without operating personnel, and without modifications to the server.

Other features and advantages of the present invention will be apparent to persons skilled in the art from the following detailed description of the illustrated embodiment accompanied by the attached drawing wherein identical reference numerals will refer to like parts in the various views.

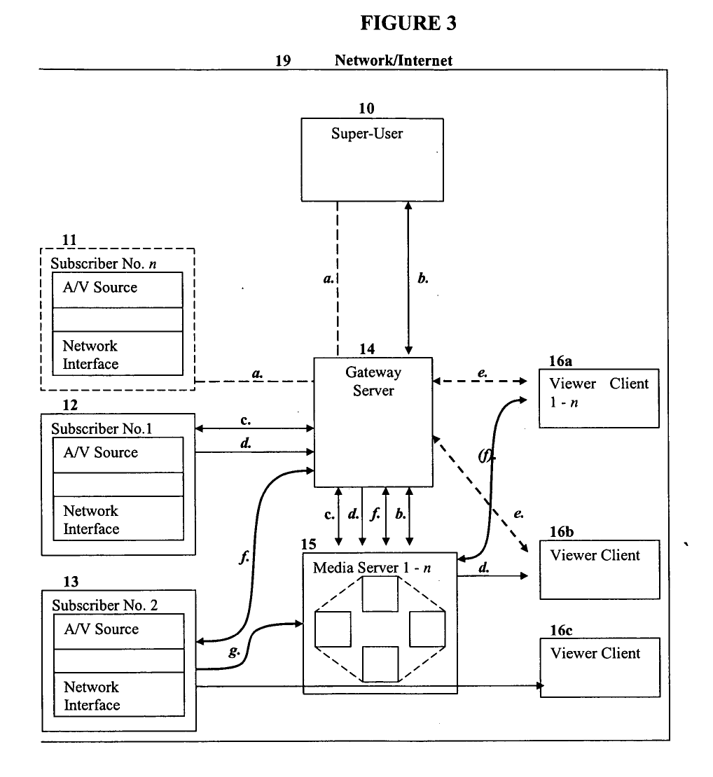

Referring first to FIG. 3, reference numeral 10 represents a “super-user” account that may (1) create sub-users (subscribers reference 11) in conjunction with gateway server 14, via line a; as well as (2) manage aspects of existing subscribers accounts, 12 and 13, e.g. bandwidth limits, capacity, media paths, etc. via gateway server 14; (3) manage certain network resources, e.g. media server capacity or limits, re-routing of media etc., for the purpose of efficiently managing the CDN or larger system via the gateway server 14 (arrow b.). Further, a level of redundancy, security and network administration is thus appreciated and provides for the efficient administration of certain business and infrastructural resources.

An individual subscriber 12 independently may generate live encoded a/v data and communicate the data via a network 19 (via arrow b.) to a media server(s) 15, who has been authenticated (arrow c.) and granted certain rights, permissions, and or limitations by gateway server 14, gains certain limited and managed access to media server(s) 15 where the streamed video data is processed, or archived, as will be described. The network 19 may be, but is not limited to the Internet.

Reference 13 illustrates an individual subscriber who after authenticating (arrow f.) uploads previously encoded content to his/her designated storage area (arrow g.) with the intent to distribute content to viewers or an audience.

Also included in FIG. 3, blocks 16a, 16b and 16c represent individual viewer clients. Each of the viewer clients 16a-16c is independent of the others, and each viewer client may be associated with one or more provider clients. That is, the grouping of viewer clients is subject only to their being authorized to have access to video files by the associated subscribers which have produced, streamed and/or archived those video files.

In FIG. 3, viewer client 16a request media stream (f) through gateway server 14 (arrow e.) and is granted access to media stored by subscriber 13. Viewer client 16b requests a live media stream from subscriber 12 through gateway server 14 and is granted access by the gateway server 14 after it determines if the live stream is active, if there are any credentials required for viewing and if so, are the current requesters credentials valid. Alternatively, subscriber No. 2 (13) may also communicate via a peer-to-peer or computer to computer connection bypassing the gateway server 14 and the media servers 15 (1-n).

In operation, each individual subscriber 11, 12 and 13 of FIG. 3, may be simultaneously generating streamed video data to a number of different viewer clients, uploading various media clips for on-demand distribution and automatically notifying potential viewers of their availability and location. It is important to note that the media delivery is performed by the media server software separate from that of this software.

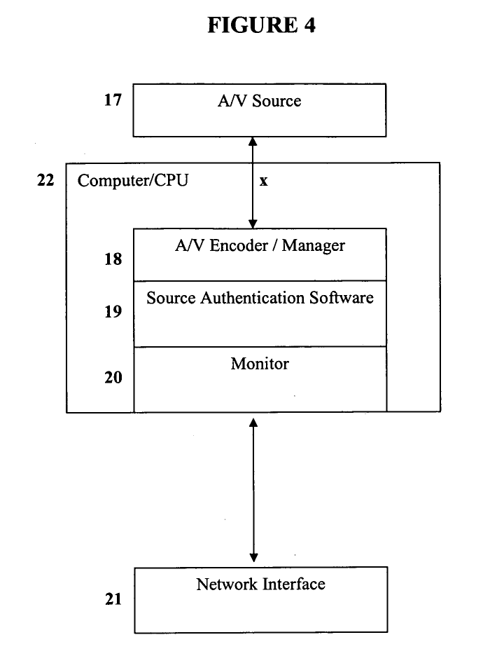

As illustrated in FIG. 4, a “typical subscriber apparatus” is comprised of a central processing unit 22 with an operating system, an a/v source 17 (e.g., DV Camera, web cam, tape deck or archival file), A/V encoder/manager 18, and source authentication software 19 contained in the CPU 22 operating system, a monitor 20, and a network interface 21 for connecting the apparatus or subscriber to the Internet. In the typical apparatus, video data is fed to the encoder/manager software 18, which provides signals in digital form along line x into a computer or PC 20. The computer 20 may be of any number of commercially available designs, preferably including a display monitor 21 and internal software 19 for (a) providing authentication information identifying itself to the gateway server 14, identifying the file being generated and (b) the source identification information necessary to receive authorization and or other data from the gateway server 14, and (c) information identifying the set of user clients authorized to access the particular video file(s) being generated. It's important to note that A/V encoder/manager 18 may also utilize files in resonant memory or archive files stored locally for the purposes of broadcasting or uploading to their subscriber account storage area for later distribution. The subscriber apparatus may also include a wired or wireless network connection card which are commercially available and used to connect the subscriber to the internet or other communications network. Subscribers may alternately be connected to the Internet by a Local Area Network, xDSL, high speed cable modem or other direct land-based connection, as well as satellite, microwave, radio or the like as well as future WAN connection methods and technologies. Such applications as security or surveillance may not require a wireless connector. It will be observed that there is no need for a server at the subscriber location. Therefore, as will be further understood from subsequent description, the actual apparatus required by a subscriber, in order to provide real time video streaming is comparatively small in size and inexpensive, and could easily be fit into a casing the size of a hand-held camera or the like. This feature expands the use applications and flexibility of the invention.

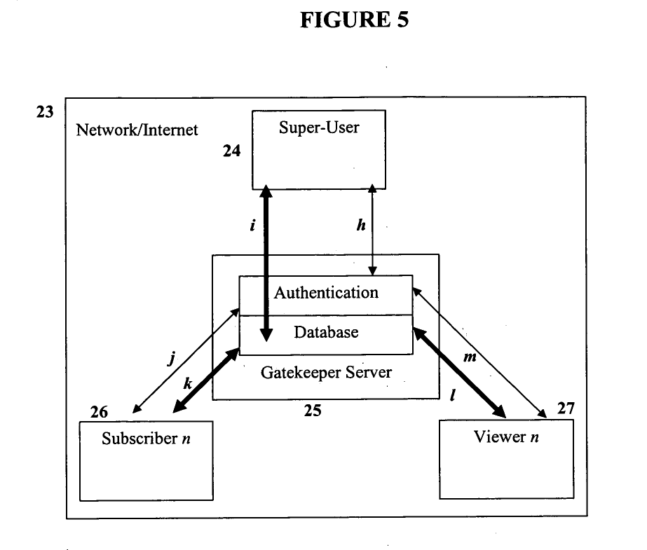

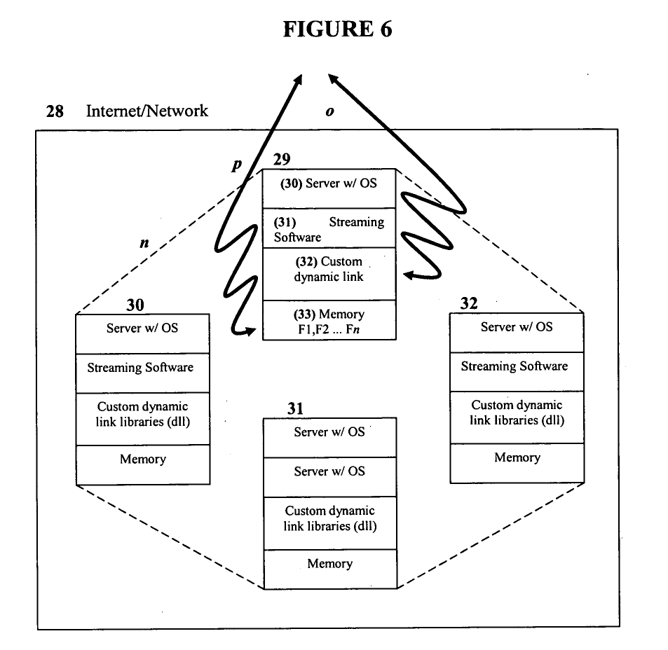

Gatekeeper server 14 of FIG. 3 and its relationship to subscriber and viewer is more thoroughly illustrated in FIG. 5. The server may be any commercially available server, requires database software e.g. My SQL, Microsoft SQL, etc. and uses industry standard web protocols and language combined with certain proprietary code for the purposes of input by super-users and subscribers alike. It will be appreciated that super-users naturally have the ability to manipulate certain information about the subscriber, their account and there available bandwidth, payment methodology, limits on the account and the like. Subscribers however, are limited in the amount of information displayed and have the ability to manipulate or change only certain things about their account (e.g., payment method, address, account limits and acceptable overages and the like). The database accepts input from super-users and subscribers via a web interface containing tables for the input of user data. It may be further appreciated that the gateway server 25, serves the function of (1) authenticating super-users 24 for the purpose of account creation and management (arrow h), (2) authentication of subscriber 26 (arrow j), (3) association of subscriber's rights, parameters, limits, account information, and live media path location (arrow k) (super-users may post information to the database (arrow i) that re-routs subscribers media paths automatically for the purposes of network load balance), (4) as well as act as a virtual “field marshal” for both super-users 24 and subscribers 26, viewer 27 and the associated content, by (a) credentialing (arrow l) of certain content (requiring username and password for viewers of certain content, (b) monitoring and updating subscriber statistics (arrow k), usage and audience size, as well as (c) monitoring network bandwidth utilization and facilitating dynamic “on-the fly” adjustments to the distribution network to compensate for bandwidth load (arrow i). e.g. “server x is at 75% capacity, instruct all subscribers from this point forward to route streams through server z.”

FIG. 6 illustrates a typical media server configuration, accessible to subscriber and supers users alike, via reference numeral 28, the Internet and may consist of multiple servers 29-32, interconnected by reference numeral n, a Local Area Network (LAN). Servers may also be spread over a geographic area and interconnected geographically by the Internet 28 and locally by n, a LAN. Servers included reference numeral 30, an operating system, reference numeral 31, software for processing the incoming streaming video data that is commercially available from Microsoft, Apple, Real Networks or other manufacturers or developer of streaming media encoders and codecs and reference numeral 32 certain custom dynamic link libraries. The server(s) 29-32 communicate with or include memory or storage represented by the block 33, which forms an archival storage memory for indexing, identifying and storing the incoming video files, schematically represented respectively as F1, F2 . . . Fn. Unique data regarding subscribers permissions, allotments, usage, security, URL paths, viewer status, security and the like are communicated via arrow o from the gateway server (database) to a set of unique, customized dynamic link libraries 31 which in turn communicate with the commercial streaming software application, reference numeral 32. Collectively, the encoder/manager (previously downloaded to the subscribers PC) and developed using the commercially available object-oriented programming language C #, receives data from gateway server 14 of FIG. 3 and said data (permissions, limits, security et al) flows (or “calls) into FIG. 6 via arrow o and communicates to a set of custom dynamic link libraries that: (a) assembles the resources comprising the individual subscribers account (b) determines the resources necessary to perform the set of actions and (c) determines the allocations of disk space, bandwidth etc. Once authentication, communication and allocation of resources has occurred, the subscriber is capable of transferring video data along arrow p that continually checks resources, transfer amounts, audience size etc. Conversely, viewer clients follow a similar path as they “call” for a particular URL.

As illustrated in FIG. 3 a view client 16a-c requests a URL via arrow e, and is distributed media via arrow d. Although not illustrated in FIG. 6, it may be appreciated that the same dynamic link library method and a series of “calls” determine the activity of a particular stream and its associations, enabling a demarcation of active vs. inactive and greatly increasing the efficiency of any content delivery system.

Continuing with the authorization process at work between subscriber and the gateway server 14, subscribers are authenticated and provided access to the streaming software via hashed usemame and password values. Upon verification of this data, a string is sent from the authentication server to the software, indicating the media server 15 to which this subscriber will stream media. When user begins streaming, the media server 15 generates a publishing point, unique to the particular instance, on the server software which is used to identify and access this particular stream or file, or to retrieve it from the archive memory.

Each of the strings described above is used, respectively, to identify the subscriber currently originating and sourcing the video stream, to identify the hardware and transmission protocol of the subscriber by which the video streaming will be initiated, and to identify the initiating software. Once the identification of a subscriber is confirmed, the system is ready to transmit data comprising the video stream. Upon initiation of streaming by subscriber, the authentication credentials must match or be verified by those stored in the main server 14 in order for the server to authorize the subscriber to establish a publishing point or connection with media servers 1-n . All three identification digital strings originate from the same transmitting subscriber computer. This procedure provides a secure, reliable automated verification process and provides for verification based on subscriber fees being current and the like.

It is important to realize that there is no human intervention in this process of identification, authorization and broadcasting from the subscriber source, archiving the stored file and providing real time access to the entire set of authorized viewer clients, subject only to computer verification of the user identity.

Once the server 14 has confirmed the information sent by the subscriber, it confirms whether that subscriber has sufficient access rights to broadcast. The authentication software residing at the subscriber obtains a list of the available video and audio devices available for encoding and provides the available codec's to be used. The subscriber then provides a desired identification code, used as a token to identify the publishing point or URL, and selects a profile which identifies the quality of the video stream. The profile may be named to correspond with the lowest level of Internet connectivity with which the profile will operate.

Once the subscriber is authenticated, based on the identification parameters described above, the server accepts the requested publishing point and transmission profile specified by the subscriber and allows the subscriber to begin broadcasting within limits such as, but not limited to (i) a specific bandwidth allocated to that particular subscriber for transmission of streaming video; (ii) maximum duration of the transmission for that particular subscriber; and (iii) authority to provide or prohibit access to certain subscribers according to data stored in gateway server 14 of FIG. 3.

Subsequently, the subscriber presses a start button to begin video streaming. In short, the subscriber communicates to the gateway server 14, the identification of the publishing point; and then the subscriber provides an indication to the server that video streaming will commence, and an indication of the desired quality (i.e. available bandwidth) of the communication link for a particular video.

When the subscriber receives an acknowledgment of receipt, the video is transmitted to the media servers 15 (1-n) and distributed to the requesting viewer client(s) or to the archival storage associated with and directed by the gateway server 14.

The completion of a request from a viewer client may be accomplished in a number of different ways. The viewer client to which the video is being streamed may have a Windows® Media Player software application running on the viewer clients 16a-16c of FIG. 3 or it may have a customized media player object which requires separate authorization, which is a customized HTML or like graphically “skin” around the Windows® Media Player Object component (provided by Microsoft Corporation) or any other substantially equivalent video player software product(s) that may exist now or in the future that are capable of using the required codec to directly access the desired publishing point within main server 14. This occurs, of course, after the proper requested file has been identified and located through a scan of available publishing points by the main server 14, and after the proper identification and authorization of the subscriber. The media server 14 provides the video stream to the media player which displays the requested video stream (file) to the requesting viewer client 16a-c.

Persons skilled in the art will appreciate some of the more significant advantages of the invention which has been described. First, the source may be mobile. Specifically, it can be located in the field and it may be even on a moving vehicle. The video stream is generated in real time, but may also be archived in a file. There is no requirement that a server be located at the transmitting subscriber or source. This not only simplifies the system, but greatly frees and makes more flexible the source. All the source need include are a video source, a computer and a connection to the Internet (preferably wireless for speed and flexibility).

Further, the present system serves both subscribers and user clients, without any limitation on the number of either or the groupings of either. For example, a viewer could, subject to proper authorization and subscription, be included in as many authorized viewer groups as desired; and the same viewer could be a subscriber sourcing and serving still another set of viewer clients. Further, the video streaming is accomplished in real time as desired or it may be archived for being accessed or even re-accessed at subsequent times. Finally, streaming is accomplished automatically, whether audio or video, without human intervention, as was required in some prior art systems.

Although the present invention has been fully described in connection with the preferred embodiment thereof with reference to the accompanying drawings, it is to be noted that various changes and modifications will be apparent to those skilled in the art. Such changes and modifications are to be understood as included within the scope of the present invention as defined by the appended claims, unless they depart therefrom.

We claim:

1. A system for creating and managing a streaming audio/visual content delivery network, comprising:
a gateway server that controls access to streaming audio/visual content and through which viewers obtain authorization to receive the streaming audio/visual content;
a media server operatively connected to the gateway server and in which the streaming audio/visual content is stored for streaming distribution to authorized viewers;
at least one subscriber from which the streaming audo/visual content originates in order to be stored in the media server, the at least one subscriber being operatively connected to the gateway server and the media server; and
at least one authorized viewer operatively connected to the gateway server so as to receive authorization from the at least one subscriber through the gateway server, and operatively connected to the media server so as to receive the streaming audio/visual content therefrom after authorization from the gateway server.

2. A system according to claim 1, wherein the at least one subscriber includes an audo/visual content generating device and a network connection through which the audio/visual content generating device transmits the streaming audio/visual content to the media server.

3. A system according to claim 2, wherein the at least one subscriber includes the audo/visual content generating device and the network connection being wirelessly connected to the media server.

4. A system according to claim 1, further comprising:
an administrator user operatively connected to the gateway server and formed to at least one of create and manage a subscriber account, assign rights or parameters to the subscriber account, manage network resources, and parse information regarding subscriber usage.

5. A method for creating and managing a streaming audio/visual content delivery network, comprising the steps of:
generating in a gateway server at least one subscriber account for a subscriber from which streaming audio/visual content originates;
defining within the at least one subscriber account at least one viewer client having authorization to receive the streaming audio/visual content;
providing a streaming audio/visual content generating system for the subscriber in order to create the streaming audio/visual content;
transmitting the streaming audio/visual content from the streaming audio/visual content generating system from the subscriber and storing the streaming audio/visual content in a media server;
obtaining access authorization for the at least one viewer client from the gateway server; and
accessing the streaming audio/visual content from the media server to the at leat one viewer client after the gateway server authorizes access to the media server.

6. A method according to claim 5, wherein the step of providing a streaming audio/visual content generating system includes providing the subscriber with an audo/visual content generating device and a network connection through which the audio/visual content generating device transmits the streaming audio/visual content to the media server.

7. A method according to claim 7, wherein the step of providing a streaming audio/visual content generating system further includes wirelessly transmitting the streaming audio/visual content to the media server.

8. A method according to claim 5, wherein the step of generating in a gateway server at least one subscriber account for a subscriber from which streaming audio/visual content originates includes at least one of creating and managing the at least one subscriber account, assigning rights or parameters to the at least one subscriber account, managing network resources, and parsing information regarding subscriber usage.
